(19) United States
(12) Patent Application Publication
(10) Pub. No.: US 2017/0271900 A1
(43) Pub. Date: Sep. 21, 2017

(54) CHARGING SYSTEM

(71) Applicant: Richcom Power LLC, West Palm Beach, FL (US)

(72) Inventors: David Ray Rose, West Palm Beach, FL (US); Tzu Yung Chang, Wellington, FL (US); William Alan Klingbeil, Palmetto, FL (US)

(21) Appl. No.: 15/464,815

(22) Filed: Mar. 21, 2017

Related U.S. Application Data
(60) Provisional application No. 62/310,862, filed on Mar. 21, 2016.

(51) Int. Cl. H02J 7/00; H01R 25/00; H01R 13/05

(52) U.S. Cl. CPC H02J 7/0045; H02J 7/007; H01R 13/05; H01R 25/006

(57) ABSTRACT

A charging system includes a primary single charging bay unit and at least one secondary single charging bay unit. Each of the units has an adapter cup for receiving one of a battery and a battery-powered device for charging, an associated printed circuit board disposed beneath the adapter cup, and a primary printed circuit board disposed within the main body. The least one secondary single charging bay unit is in communication with the primary single charging bay unit via a user assembled backplane bus. The backplane bus is expandable to permit a gangable or build-out configuration of the charging system.

### CROSS-REFERENCE TO RELATED APPLICATIONS

This application claims the benefit of U.S. Provisional Application No. 62/310,862, filed on Mar. 21, 2016. The entire disclosure of the above application is hereby incorporated herein by reference.

### FIELD

The present disclosure relates to portable electronic devices and, more particularly, to systems and methods for charging batteries and battery-powered portable electrical devices.

### BACKGROUND

Rechargeable batteries and rechargeable battery packs used with electronic devices are well known in the art. These batteries and battery packs are generally required to be charged periodically, often via an external battery charger.

The typical configuration of rechargeable batteries or a rechargeable battery pack in an electronic device charger limits the end user to selecting preferences of a single, dual or six bay configuration, and thereby narrows the options available. This usually limits a charger configuration to be one device type, not allowing a mixture of different charging bays or a multi-bay charger.

There is a continuing need for a charging system that can accommodate multiple batteries or battery-powered electronic devices. Desirably, the charging system is modular to permit for simultaneous charging of a predetermined number of different portable devices and/or batteries.

### SUMMARY

In concordance with the instant disclosure, a charging system that can accommodate multiple batteries or battery-powered electronic devices, and which is modular to permit the simultaneous charging of a predetermined number of different portable devices and/or batteries, is surprisingly discovered.

In one embodiment, a charging system includes a primary single charging bay unit and at least one secondary single charging bay unit. The primary single charging bay unit has a main body with a first removable adapter cup for receiving a first electronic device for charging. The main body is configured to be placed in electrical communication with an external power supply. The at least one secondary single charging bay unit has a main body and a second removable adapter cup for receiving a second electronic device for charging. The at least one secondary single charging bay unit is in electrical communication with the primary single charging bay. Advantageously, the first electronic device and the second electronic device may be different, and the first removable adapter cup and the second removable adapter cup may likewise be configured to receive the different electronic devices. The first and second removable adapter cups may also be interchangeable.

In another embodiment, a method of forming a charging system includes placing the at least one secondary single charging bay unit in electrical communication with the primary single charging bay.

In a further embodiment, each of the units has an associated printed circuit board disposed beneath the adapter cup, and a primary printed circuit board disposed within the main body. The least one secondary single charging bay unit is in communication with the primary single charging bay unit via a user assembled backplane bus. The backplane bus is expandable to permit a gangable or build-out configuration of the charging system.

In an illustrative embodiment, the present disclosure includes a rechargeable battery pack or rechargeable batteries contained in an electronic device charging system. The charging system is modular and expandable in design, and can be easily field upgraded into any configuration the user may require without requiring an additional base frame.

The charging system can be configured from the ‘primary single bay’ charger, which charges one battery or electronic device containing a battery at a time using alternating current or direct current power inputs. The user can add one or more additional ‘secondary bays’ to make a multi-bay configuration using alternating current or direct current power inputs.

The charging system's primary single charging bay monitors the quantity of ‘secondary charging bays’ attached to the ‘primary single charging bay’ via I²C communication protocol, acting as a unique safety feature as to not over-burden the charging system's power supplies.

The charging system of the present disclosure also allows the user to charge multiple different makes and/or models of rechargeable batteries or rechargeable batteries contained in an electronic device in the same base unit, along with automatically identifying and charging different battery cell chemistries.

The charging system has an integral “user assembled backplane” which is unique in the battery charger industry. This “user assembled backplane” provides the power and I²C communication interconnects for the individual secondary charging bays back to the primary bay. The backplane consists of male/female connectors interlocking from the “primary single charging bay” to the secondary bays and in-between the secondary charging bays. The backplane also has an expansion monitoring failsafe line which monitors the number of bays connected on the backplane and allows the number to be limited according to the safe limits of the power supply, and/or connector limitations and circuit board limitations.

The charging system of the disclosure also has a unique method of ensuring that the power supply used is within the safe operating ratings of the power supply. When used as a primary single bay charger, a power supply with a lower operating voltage is provided. For example, a 12 VDC power supply is used for a single bay charger. However, for an expanded system a higher voltage supply, such as a 15 or 19 VDC, is used. This has an economic benefit due to a less expensive supply being used in the cost-sensitive “primary single bay” configuration.

An expanded system is also detected via the I²C and/or the “Bay Detect” line. The “primary single charging bay” module will not allow an expanded system to operate without the higher voltage supply. An added benefit of the higher voltage supply is that the power supply current demands are reduced slightly along the “user assembled backplane”, reducing I (Current) and R (Resistance) drops, inherent in printed circuit board traces, and in electrical connectors.

In certain embodiments, the charging system of the present disclosure can be configured from the ‘primary single bay’ charger, which charges one battery or electronic device containing a battery at a time using alternating current or direct current power inputs, and the user can add an additional ‘secondary bays’ to make a multi-bay configuration using alternating current or direct current power inputs.

In other embodiments, the charging system can electrically and mechanically accept multiple different makes and/or models of rechargeable batteries or rechargeable batteries contained in an electronic device in the same base unit along with automatically identifying and charging different battery cell chemistries.

In additional embodiments, the charging system uses a method of alignment and securing the mechanical interlock providing the mechanical and electrical interface from the “Primary Single Charging Bay” modules to one or more “Secondary Single Charging Bay” modules.

In yet further embodiments, a mechanical interconnection mechanism is formed into the ‘Primary Single charging bay’ and ‘Secondary Single Charging bay’ with the proper keyed orientation as to allow additional ‘Secondary Single Charging bays’ to be added and interlocked by the modules unique bottom plates.

In some embodiments, the charging system contains a “User Assembled Backplane” to provide power, communications, and a method of detecting the number of modules assembled into a single unit.

In yet more embodiments, the charging system contains circuitry and sensors for detecting the power capability of the connected power supply by measuring the input voltage whereas 12 VDC is used for one stand alone “Primary Single Charging Bay” module, and no “Secondary Single Charging Bay” modules connected.

In even further embodiments, when the “Primary Single Charging Bay” module detects a higher input voltage such as 15 VDC or 19 VDC, then the “Primary Single Charging Bay” module enables the power switch to allow charging in more than the “Secondary Single Charging Bay” modules.

In yet another embodiment, the charging system uses paralleled resistors to inform the “Primary Single Charging Bay” module via an I²C communication bus of the total number of modules assembled into a single functioning unit.

### DRAWINGS

The above, as well as other advantages of the present disclosure, will become readily apparent to those skilled in the art from the following detailed description, particularly when considered in the light of the drawings described hereafter.

FIG. 1 is a top perspective view of a charging system according to one embodiment of the present disclosure, showing a simultaneous charging of different types of electronic devices, batteries, or battery packs;

FIG. 2 is an electrical diagram illustrating a communication protocol between a primary single charging bay and a plurality of secondary single charging bays of the charging system depicted in FIG. 1;

FIG. 3 is a top perspective view of a primary single charging bay for use in the charging system depicted in FIG. 1, according to one embodiment of the disclosure;

FIG. 4 is an exploded perspective view of the primary single charging bay depicted in FIG. 3;

FIG. 5 is an exploded perspective view of a secondary single charging bay for use in the charging system depicted in FIG. 1, according to one embodiment of the disclosure;

FIG. 6A is a bottom perspective view of the primary single charging bay shown in FIGS. 3-4;

FIG. 6B is a partly exploded bottom perspective view of the primary single charging bay shown in FIG. 6A, with a rear end cap having been removed to exposed the underlying mechanical and electrical connectors;

FIG. 6C is a partly exploded bottom perspective view of the primary single charging bay depicted in FIGS. 3-4 and 6A-6B, together with a plurality of the secondary single charging bays depicted in FIG. 5, prior to assembly;

FIG. 6D is a top perspective view of a field build-out of the primary single charging bay depicted in FIGS. 3-4 and 6A-6B together with a plurality of the secondary single charging bays depicted in FIG. 5;

FIG. 7 is a fragmentary bottom perspective view of the primary single charging bay depicted in FIGS. 3-4 and 6A-6D before connection with the secondary single charging bay depicted in FIG. 5, and further showing a mechanical interface between the primary single charging bay and the secondary single charging bay; and

FIG. 8 is a fragmentary bottom perspective view of the primary single charging bay depicted in FIGS. 3-4 and 6A-6D before connection with the secondary single charging bay depicted in FIG. 5, and further showing a power and communication interface between the primary single charging bay and the secondary single charging bay.

### DETAILED DESCRIPTION

The following description is merely exemplary in nature and is not intended to limit the present disclosure, application, or uses. It should also be understood that throughout the drawings, corresponding reference numerals indicate like or corresponding parts and features. In respect of the methods disclosed, the order of the steps presented is exemplary in nature, and thus, is not necessary or critical unless otherwise disclosed.

The singular forms “a,” “an,” and “the” can include plural referents in the present disclosure unless the context clearly dictates otherwise. Thus, for example, reference to “a secondary single charging bay unit” can, but doesn't not necessarily, include reference to one or more of such units.

As used herein, relative terms, such as “top,” “bottom,” “upper,” “lower,” “front,” “rear,” etc., are used to refer to various components of the charging system discussed herein, as those terms would be readily understood by one of ordinary skill in the relevant art. It is to be understood that such terms in no way limit the present disclosure, but are used to aid in describing the components of the charging systems of the disclosure in the most straightforward manner.

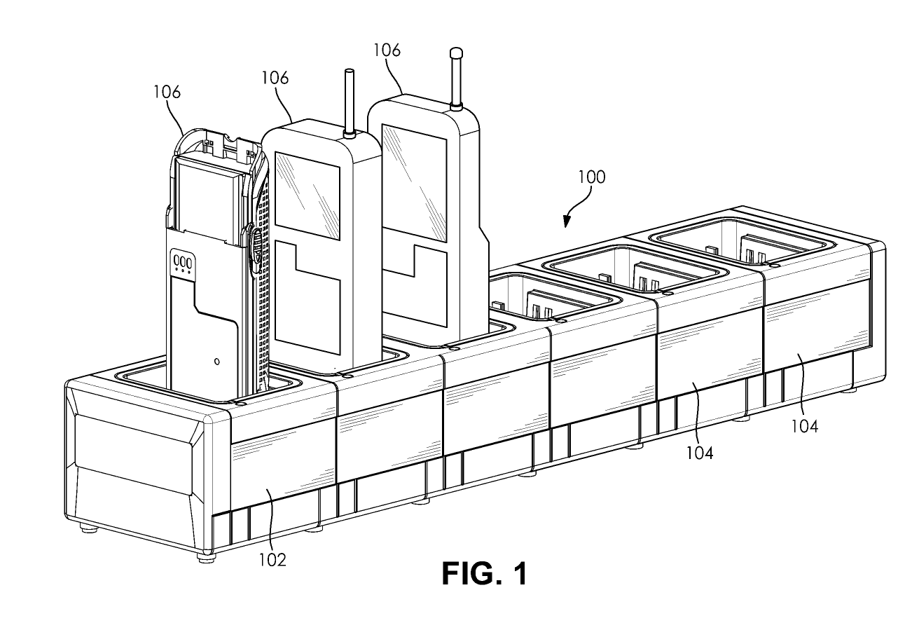

FIGS. 1-8 illustrate a charging system 100 and the components thereof, according to various embodiments of the present disclosure. As shown in FIG. 1, the charging system 100 is modular. The charging system 100 has a primary single charging bay unit 102, and one or more secondary single charging bay units 104 selectively connected with the primary single charging bay unit 102. Each of the primary single charging bay unit 102 and the secondary single charging bay unit 104 is configured to receive an electronic device 106 such as a battery, a battery pack, or a battery-powered electrical component or unit such as a portable radio, smart phone, and the like, for purposes of charging or recharging the same.

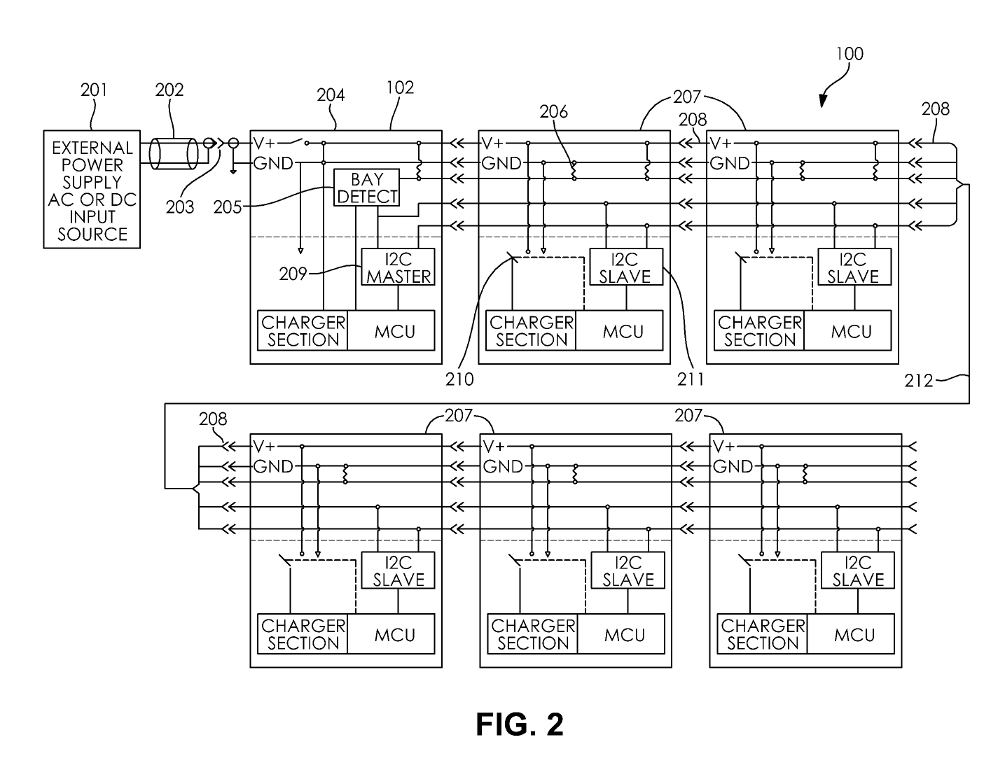

Referring now to FIG. 2, an external power supply 201 for the charging system 100, discussed hereinabove, may be 12 VDC for a single bay configuration, and 15 VDC or higher for a multi-bay configuration. Other suitable VDC for the external power supply 201 may be selected by a skilled artisan, as desired.

In FIG. 2, an interconnect cable 202 is in communication with both the power supply 201 and the primary single charging bay unit 102 and the plurality of secondary single charging bay units 104. The interconnect cable 202 has a male or female connector 203 that is configured to be placed in communication with the primary single charging bay unit 102.

A block representation of the primary single charging bay unit 102 is identified by reference number 204, and block representations of the secondary single charging bay unit 104 are identified by reference number 207, in FIG. 2. The primary single charging bay unit 102 has an electronic circuit (titled “Bay Detect”) that is configured to detect the number of modules interconnected via the “user assembled backplane” to form a complete assembly of the charging system 100.

As shown in FIG. 2, each of the secondary single charging bay units 102 has a bay detect sense resistor 206 installed therein. The parallel value of this resistor 206 determines the number of bays in a complete assembly of the charging system 100, and reports this information to the MCU (microprocessor) in the primary charging single bay unit 102.

The male or female electrical connectors 208 shown in FIG. 2 join each module (i.e. the primary single charging bay unit 102 and the secondary single charging bay units 104) together. For example, there is one female connector 208 on the primary charging single bay unit 102, a male connector 208 on one side of each of the secondary charging single bay units 104, and a corresponding female connector 208 on the opposite side of each of the secondary charging single bay units 104.

In FIG. 2, a schematic representation of the I²C communications system 209 is also shown. This communications system 209 also informs the microprocessor in the primary charging single bay unit 102 of the number of modules connected, as well as other data transfer functions. The I²C master resides in the primary charging single bay unit 102.

A schematic representation of a power switch 210, which controls the power to each secondary charging single bay unit 104, and which can also be enabled or disabled by an I²C command issued by the primary charging single bay unit 102, is also shown in FIG. 2.

A schematic representation of an I²C slave communications interface 211 is further shown in FIG. 2. The I²C slave communications interface 211 is contained in each secondary charging single bay unit 104.

FIG. 2 also depicts a schematic representation of a user assembled backplane bus 212.

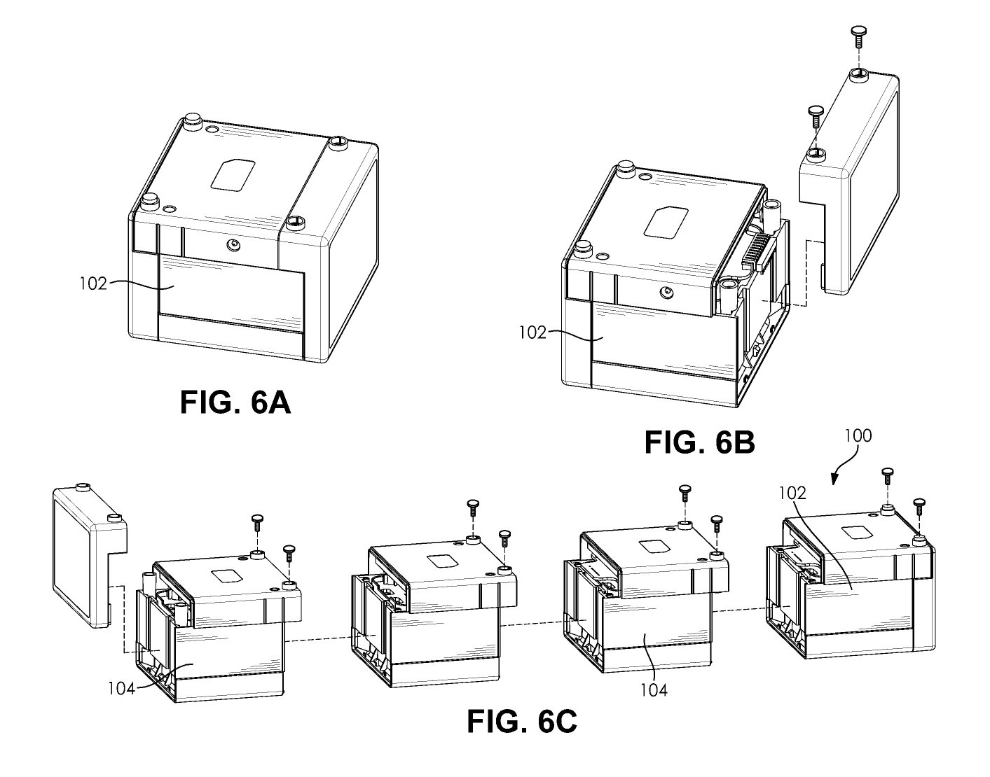

Although shown in FIGS. 1-2 having five secondary single charging bay units 104 connected with the primary single charging bay unit 102, one of ordinary skill in the art may select any suitable number of the secondary single charging bay units 104 to connect with the primary single charging bay unit 102, as desired. For example, as shown in FIGS. 6C-6D, the charging system 100 may have three secondary single charging bay units 104 connected with the primary single charging bay unit 102.

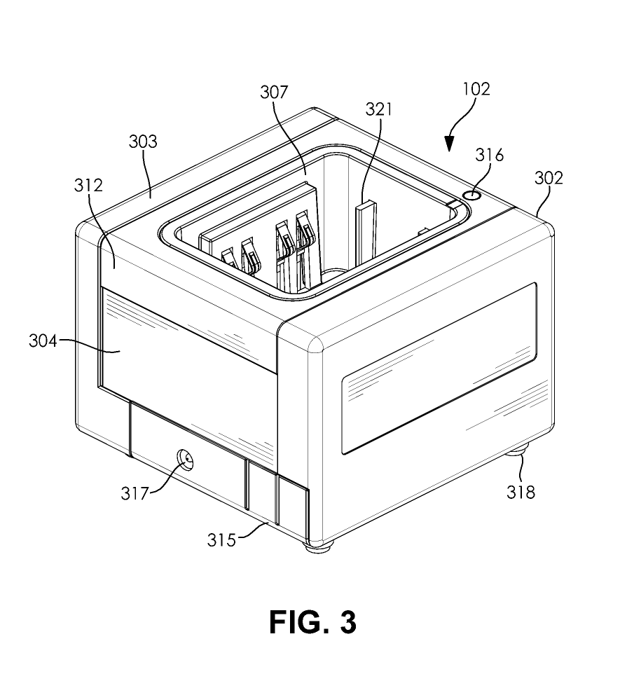

The primary single charging bay unit 102 and the second single charging bay units 104 are described in further detail herein below, with respect to FIGS. 3-8. In FIG. 3, the primary single charging bay unit 102 is shown fully assembled as a single unit. The primary single charging bay unit 102 has front end cap 302 and a rear end cap 303. The front end cap 302 and the rear end cap 303 are connected on opposite ends of a main body 304. Each of the front end cap 302 and the rear end cap 303 may be selectively removed from the main body 304.

As non-limiting examples, the front end cap 302 and the rear end cap 303 may be formed from molded plastic, and the main body 304 may be formed from an extruded aluminum. One of ordinary skill in the art may also select other suitable materials and manufacturing methods for the front end cap 302, the rear end cap 303, and the main body 304 of the primary single charging bay unit 102, as desired.

The primary single charging bay unit 102 further has an adapter cup 307. The adapter cup 307 is configured to receive one of the portable electronic devices 106 (shown in FIG. 1). The adapter cup 307 is disposed through an aperture formed in a top plate 312 of the primary single charging bay unit 102. The adapter cup 307 may be interchangeable to accommodate different sizes and types of portable electronic devices 106. For example, each adapter cup 307 may have different internal features 321 such as ribs, slots, connectors and the like that are configured to mate, provide a friction fit with, or otherwise securely hold specific portable electronic devices 106.

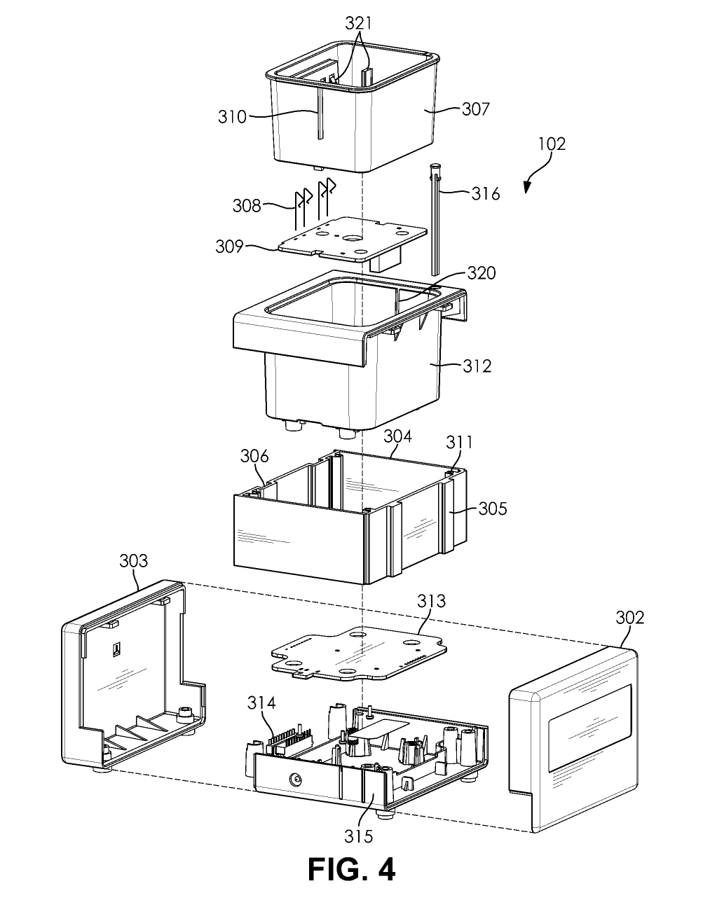

As shown in FIG. 4, the top plate 312 is disposed between the front end cap 302 and the rear end cap 303, and arranged on an upper region of the main body 304. In one example, the top late 312 is formed from molded plastic. However, a skilled artisan may also select other suitable materials and manufacturing methods for the top plate 312 within the scope of the present disclosure.

The top plate 312 also has an LED display 316 formed therein. The LED display 316 is in communication with a control printed circuit board 313 (also shown in FIG. 2) that is disposed inside of the main body 304. The LED display 316 may be configured to show that the primary single charging bay unit 102 is powered on or off. The LED display 316 may further be configured to show different states of charge of the electronic device 106 disposed within the adapter cup 307 in operation, for example, by having different colors or intensities of light displayed. One of ordinary skill in the art may select suitable types and configurations for the LED display 316, as desired.

With further reference to FIG. 4, the primary single charging bay unit 102 further has a bottom plate 315. The bottom plate 315 is also disposed between the front end cap 302 and the rear end cap 303. The bottom plate 315 may further have a DC receptacle 317 formed therein, shown in FIG. 3, which is in communication with the main control printed circuit board 313 (also shown in FIG. 2). Like the top plate 312, the bottom plate 315 may be formed from molded plastic, or from other suitable materials and manufacturing methods, as desired.

With renewed reference to FIG. 3, and as shown further in FIGS. 6A-6D, the bottom plate 315 may also have feet 318 or cushions selectively attached thereto, typically made of rubber or another soft polymer, which militate against a sliding of the primary single charging bay unit 102 and the secondary single charging bay units 104 on a surface where they are disposed during a charging operation. For example, the feet 318 may be disposed at the ends of threaded rods, which can engage with threaded holes formed in the bottom plate 315. Other suitable means for attaching the feet 318 to the bottom plate 315 may also be used within the scope of the disclosure.

As shown in FIG. 4 the main body 4 of the primary single charging bay unit 102 has male features 305 and female locking guides 306. The male features 305 and the female locking guides 306 are disposed on opposite sides of the main body 304. The main body 304 also houses retaining holes 311. Fasteners such as screws, bolts and the like may be used with the retaining holes 311 to selectively mount top cover plate 312 and bottom plate 315 to the main body 304.

The adapter cup 307 of the primary single charging bay unit 102 is also shown in FIG. 4. The adapter cup 307 receives the portable electronic device 106, which is placed in contact with an associated printed circuit board 309 via interface contacts 308. The adapter cup 307 further has a key feature 310 formed in an outer surface thereof for orientation of the adapter cup 307 by alignment with a cooperating channel 320 feature formed into the main body 304 of the primary single charging bay unit 102.

It should be appreciated that many different types of the adapter cup 307, all receivable by the main body 304 but configured to accommodate differently sized and differently shaped electronic devices 106, may be provided or used in the system 100 of the present disclosure.

As further shown in FIG. 4, the main control printed circuit board 313 is disposed within the main body 304 beneath the top plate 312 and the associated printed circuit board 309, and above the over lapping bottom plate 315. A power and I²C communication bus 314 is formed through the rear end cap 303 and in communication with the main control printed circuit board 313. The LED light indicator post 316 is also disposed through the top plate 312 and in communication with the main control printed circuit board 313.

In one non-limiting example, the main body item 304 has the male features 305 and the female locking guides 306 situated on opposite sides of the main body 304. It should be appreciated that this configuration allows for the innovative ability of the primary single charging bay unit 102 to be expanded into a rugged and durable multi-bay charging system 100, by use one or more secondary single charging bay units 104, with many options available for the end user.

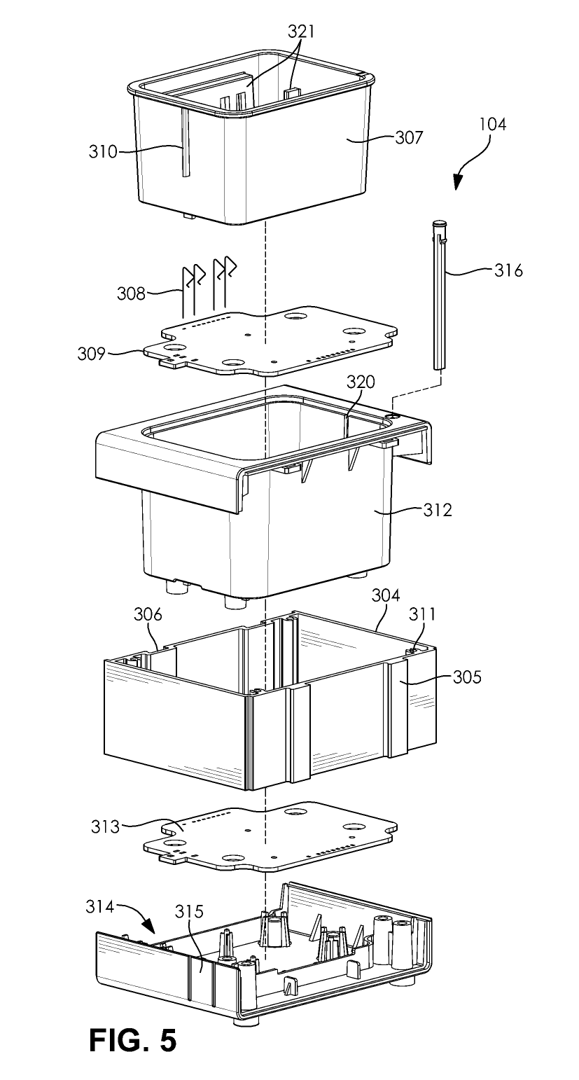

FIG. 5 is an exploded perspective view of the secondary single charging bay unit 104 of the present disclosure. Due to certain structural similarities of the primary single charging bay unit 102 and the secondary single charging bay unit 104, like or related features to that found in the primary single charging bay unit 102 are identified with respect to the secondary single charging bay unit 104 with the same reference number, for purpose of clarity.

The secondary single charging bay unit 104 has the male features 305 and the female locking guides 306 disposed on opposite sides of the main body 304. The secondary single charging bay unit 104 also has the retaining holes 311 for mounting the top cover plate 312 and the bottom plate 315 to the secondary single charging bay unit 104. Fasteners such as screws, bolts, and the like may be used with the retaining holes 311 to mount top cover plate 312 and the bottom plate 315 to the main body 304 of the secondary single charging bay unit 104.

The secondary single charging bay unit 104 also has the adapter cup 307 for receiving the portable electronic device 106 or the rechargeable battery 106. In operation, the adapter cup 307 receives the portable electronic device 106 or the rechargeable battery 106, which is placed in contact with an associated printed circuit board 309 via the interface contacts 308. The adapter cup 307 further has the key feature 310 formed in an outer surface thereof for orientation of the adapter cup 307 by alignment with the cooperating channel feature into the main body 304 of the primary single charging bay unit 102.

As shown in FIG. 5, the secondary single charging bay unit 104 also has a main control printed circuit board 313. The main control printed circuit board 313 is disposed within the main body 304 of the secondary single charging bay unit 104 beneath the top plate 312 and the associated printed circuit board 309, and above the over lapping bottom plate 315. A power and I²C communication bus 314 is in communication with the main control printed circuit board 313. The LED light indicator post 316 is also disposed through the top plate 312 and in communication with the main control printed circuit board 313.

As one non-limiting example, the main body 304 has the male features 305 and the female locking guides 306 situated on opposite sides of the main body 304. This configuration allows for the innovative ability of the secondary single charging bay unit 104 to be expanded into a rugged and durable multi-bay charging system 100 with many options for the end user.

FIGS. 6A-6B show a field build-out of the charging system 100, having both the primary single charging bay unit 102 and a plurality of secondary charging bay units 104, as detailed hereinabove in FIGS. 1-5.

In operation, the end user first obtains the primary single charging bay unit 102, as shown in FIG. 6A, and then removes the rear end cap 303 from the primary single charging bay unit 102, as shown in FIG. 6B. The secondary single charging bay unit 104 is then guided in from the bottom of the primary single charging bay unit 102 using the unique extruded male features 305 and the female locking guides 306. Two fasteners such as screws, bolts, etc. are then installed to complete a 2-bay configuration of the charging system 100.

By repeating the aforementioned assembly steps, and as shown in FIG. 6C, additional secondary single charging bay units 104 can be added by the end user. In one non-limiting example, as shown in FIGS. 6D, the charging system 100 can have up to four (4) bays. In another non-limiting example, as shown in FIG. 1, the charging system 100 can have up to six (6) bays. One of ordinary skill in the art may select other suitable numbers of bays for the charging system 100, as desired.

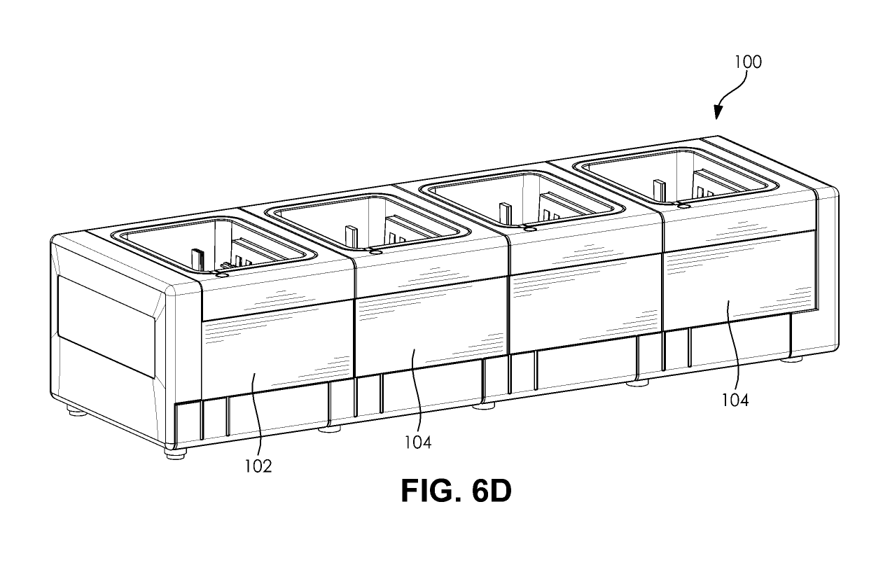

Referring now to FIG. 7, a mechanical interface between the primary single charging bay unit 102 and the secondary single charging bay unit 104 is shown. In operation, and as shown in FIG. 7, the male guide 305 of the primary single charging bay unit 102 may interfaced with the female locking guide 6 of the secondary single charging bay unit 104.

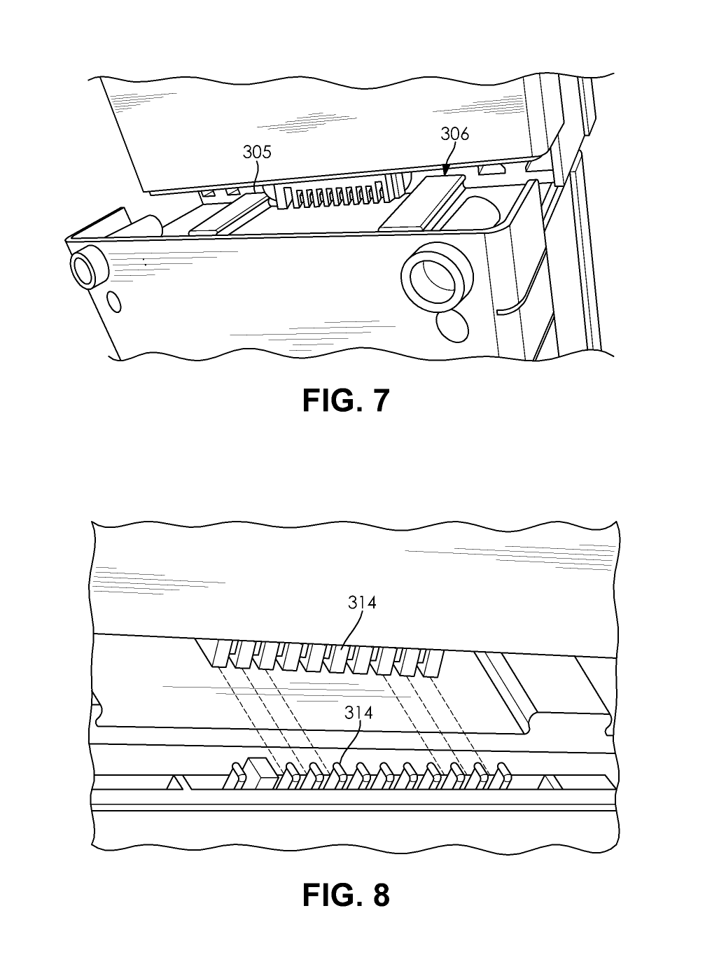

With reference to FIG. 8, an electrical backplane interface between the bus 314 of the primary single charging bay unit 102 and the bus 314 of the secondary single charging bay unit 104 is shown. It should be appreciated that this is a power and communication interface between the primary single charging bay unit 102 and of the secondary single charging bay unit 104.

Advantageously, the charging system 100 of the present disclosure has a common backplane and multiple bays for receiving and charging both AC and DC chargeable batteries, in combination simultaneously. The multiple charging bays and a parallel resistor means are used to detect the number of modules or units in place. Additionally, the charging system 100 may have “slave” modules that will charge at higher voltages than the primary charging module upon demand. Furthermore, the charging system 100 is, in combination, gangable with an expandable backplane, and with each module containing a programmable AC/DC charger.

While certain representative embodiments and details have been shown for purposes of illustrating the invention, it will be apparent to those skilled in the art that various changes may be made without departing from the scope of the disclosure, which is further described in the following appended claims.

What is claimed is:

1. A charging system, comprising:
a primary single charging bay unit having a main body with a first removable adapter cup for receiving a first electronic device for charging, the main body configured to be placed in electrical communication with an external power supply; and
at least one secondary single charging bay unit having a main body and a second removable adapter cup for receiving a second electronic device for charging, the at least one secondary single charging bay unit in electrical communication with the primary single charging bay.

2. The charging system of claim 1, wherein each of the primary single charging bay unit and the at least one secondary single charging bay unit has an electrical connector for placing the primary single charging bay unit and the at least one secondary single charging bay unit in electrical communication with one another.

3. The charging system of claim 1, wherein the main body of the primary single charging bay includes a top plate and a bottom plate, the top plate having an aperture formed therein that receives the first removable adapter cup.

4. The charging system of claim 3, wherein the bottom plate has a plurality of feet threadably attached thereto.

5. The charging system of claim 3, wherein the primary single charging bay unit includes an associated printed circuit board disposed beneath the first removable adapter cup and a primary printed circuit board disposed within the main body of the primary single charging bay unit between the top plate and the bottom plate.

6. The charging system of claim 5, wherein one of the associated printed circuit board and the primary printed circuit board of the primary single charging bay unit has a bay detect unit that is configured to detect a number of bay modules forming the charging system.

7. The charging system of claim 6, wherein the primary single charging bay unit further has a microprocessor, the microprocessor in communication with and receiving the number of modules forming the charging system from the bay detect unit.

8. The charging system of claim 7, wherein the microprocessor further provides an appropriate charge to the first electronic device when inserted into the first removable adapter cup.

9. The charging system of claim 3, wherein the primary single charging bay unit further includes a removable rear end cap.

10. The charging system of claim 3, wherein the primary single charging bay unit has male features and female locking guides disposed on opposite sides of the main body of the primary single charging bay unit.

11. The charging system of claim 10, wherein the at least one secondary single charging bay unit has male features and female locking guides disposed on opposite sides of the main body of the least one secondary single charging bay unit, the male features of the least one secondary single charging bay unit received by the female locking guides of the primary single charging bay unit.

12. The charging system of claim 1, wherein the main body of the at least one secondary single charging bay includes a top plate and a bottom plate, the top plate having an aperture formed therein that receives the second removable adapter cup.

13. The charging system of claim 12, wherein the at least one secondary single charging bay unit includes an associated printed circuit board disposed beneath the adapter cup and a primary printed circuit board disposed within the main body of the at least one secondary single charging bay unit.

14. The charging system of claim 13, wherein the at least one secondary single charging bay unit further has a microprocessor, the microprocessor providing a predetermined charge to the second electronic device when inserted into the second removable adapter cup.

15. The charging system of claim 11, wherein the at least one secondary single charging bay unit further includes a removable front end cap and a removable rear end cap.

16. A primary single charging bay unit for a charging system, comprising:
a main body configured to be placed in electrical communication with an external power supply;
a top plate having an aperture formed therein;
a first removable adapter cup for receiving a first electronic device for charging, the first removable adapter cup disposed in the aperture of the top plate;
a bottom plate spaced apart from the top plate;
a removable rear end cap selectively coupled to the main body;
an associated printed circuit board disposed beneath the first removable adapter cup, wherein the associated printed circuit board is configured to determine a type of the first electronic device for charging;
and a primary printed circuit board disposed within the main body of the primary single charging bay unit, wherein the primary circuit board is configured to determine a number of bay modules forming the charging system.

17. A method for assembly of a charging system, comprising:
providing a primary single charging bay unit having a main body with a first removable adapter cup for receiving a first electronic device for charging, the main body configured to be placed in electrical communication with an external power supply;
providing at least one secondary single charging bay unit having a main body and a second removable adapter cup for receiving a second electronic device for charging; and
placing at least one secondary single charging bay unit in electrical communication with the primary single charging bay.

18. The method of claim 17, further comprising a step of mechanically connecting the at least one secondary single charging bay unit with the primary single charging bay.

19. The method of claim 17, wherein the primary single charging bay unit has a removable rear end cap, and the method includes a step of removing the rear end cap to expose mechanical connectors prior to placing the at least one secondary single charging bay unit in electrical communication with the primary single charging bay.

20. The method of claim 19, further comprising a step of placing the rear end cap of the primary single charging bay unit on the at least one secondary single charging bay unit, whereby the charging system is fully assembled.
